(19) United States
(12) Patent Application Publication
(10) Pub. No.: US 2026/0100121 A1
(43) Pub. Date: Apr. 9, 2026

(54) SYSTEMS, APPARATUSES, AND METHODS FOR ENHANCED REMOTE MONITORING

(71) Applicant: Project Monitor, Inc. DBA Harbor, Dallas, TX (US)

(72) Inventors: Kevin Lavelle, Dallas, TX (US); Charlie Hill, Dallas, TX (US)

(21) Appl. No.: 19/418,044

(22) Filed: Dec. 12, 2025

Related U.S. Application Data
(62) Division of application No. 18/787,494, filed on Jul. 29, 2024.
(60) Provisional application No. 63/516,241, filed on Jul. 28, 2023.

(51) Int. Cl. G08B 21/02

(52) U.S. Cl. CPC G08B 21/0225; G08B 21/023; G08B 21/0236; G08B 21/0277

(57) ABSTRACT

Methods, apparatuses, and systems are described for capturing images and audio of a scene or environment. A motion threshold may be associated with the captured images and an audio threshold may be associated with the captured audio of the scene or environment. Based on the motion threshold being exceeded for a first length of time, the audio threshold being exceed for a second length of time, or both, an alert may be sent to one or more user devices.

### CROSS REFERENCE TO RELATED PATENT APPLICATIONS

This application is a divisional of U.S. application Ser. No. 18/787,494, filed Jul. 29, 2024, which claims priority to U.S. Provisional Patent Application No. 63/516,241 , filed on Jul. 28, 2023, which are hereby incorporated by reference in their entirety.

### BACKGROUND

Baby monitoring systems are commonly used to watch over babies or children from afar. Conventional baby monitoring systems offer various high-tech features that include alerting the operators of the baby monitoring systems via cloud-based mobile push notifications when an audio threshold or a motion threshold has been exceeded. However, these baby monitoring systems do not incorporate a length of time a threshold has been exceeded for sending alert notifications or determine which operator should receive the alert notifications. Furthermore, conventional baby monitoring systems usually output noise, such as static noise, white noise, and/or background noise, even if no sound is detected in the area being monitored. Moreover, in situations involving parents in need of professional night-nurses or pediatric services, the parents must either utilize services that are expensive and in-person or utilize services that are disparate and not integrated with the technology they use in the home.

### SUMMARY

It is to be understood that both the following general description and the following detailed description are exemplary and explanatory only and are not restrictive.

Methods, systems, and apparatuses systems for improved data processing and alert notifications based on an environment being monitored by a data capture device are described. A data capture device (e.g., camera, monitoring device, microphone, etc.) connected to a network may generate and/or maintain images and audio of a scene/environment that may include a subject/individual being monitored. A motion threshold may be associated with the captured images of the scene/environment and an audio threshold may be associated with the captured audio of the scene/environment. In addition, the motion threshold may be further associated with a first length of time and the audio threshold may be further associated with a second length of time. The data capture device may send an alert notification to one or more user devices based on the motion threshold being exceeded for a first length of time and/or the audio threshold being exceeded for the second length of time.

In an embodiment, are methods comprising acquiring, via a data capture device, one or more images of a subject and audio of the subject, determining, based on the one or more images of the subject, that a motion threshold has been exceeded for a first length of time, determining, based on the audio of the subject, that an audio threshold has been exceeded for a second length of time, and based on the motion threshold being exceeded for the first length of time and the audio threshold being exceeded for the second length of time, sending, via a local area network, a notification to one or more user devices.

In an embodiment, are methods comprising acquiring, via a data capture device, one or more images of a subject and audio of the subject, withholding sending a notification, based on the one or more images of the subject indicating that a motion threshold has not been exceeded for a first length of time, withholding sending a notification, based on the audio of the subject indicating that an audio threshold has not been exceeded for a second length of time, determining, based on the one or more images or the audio, an occurrence of a notification override event, and based on the notification override event, sending, via a local area network, a notification to one or more user devices.

In an embodiment, are methods comprising acquiring, via a data capture device, one or more images of a subject, determining, based on the one or more images of the subject, that a motion threshold has been exceeded for a first length of time, and based on the motion threshold being exceeded for the first length of time, sending, via a local area network, a notification to one or more user devices.

In an embodiment, are methods comprising acquiring, via a data capture device, audio of a subject, determining, based on the audio of the subject, that an audio threshold has been exceeded for a first length of time, and based on the audio threshold being exceeded for the first length of time, sending, via a local area network, a notification to one or more user devices.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of the present description serve to explain the principles of the apparatuses and systems described herein:

FIG. 1 shows an example system;

FIG. 2 shows an example system environment;

FIG. 3 shows an example system environment;

FIG. 4 shows a flowchart of an example method;

FIG. 5 shows a flowchart of an example method;

FIG. 6 shows a flowchart of an example method;

FIG. 7 shows a flowchart of an example method; and

FIG. 8 shows a block diagram of an example system and computing device.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

This detailed description may refer to a given entity performing some action. It should be understood that this language may in some cases mean that a system (e.g., a computer) owned and/or controlled by the given entity is actually performing the action.

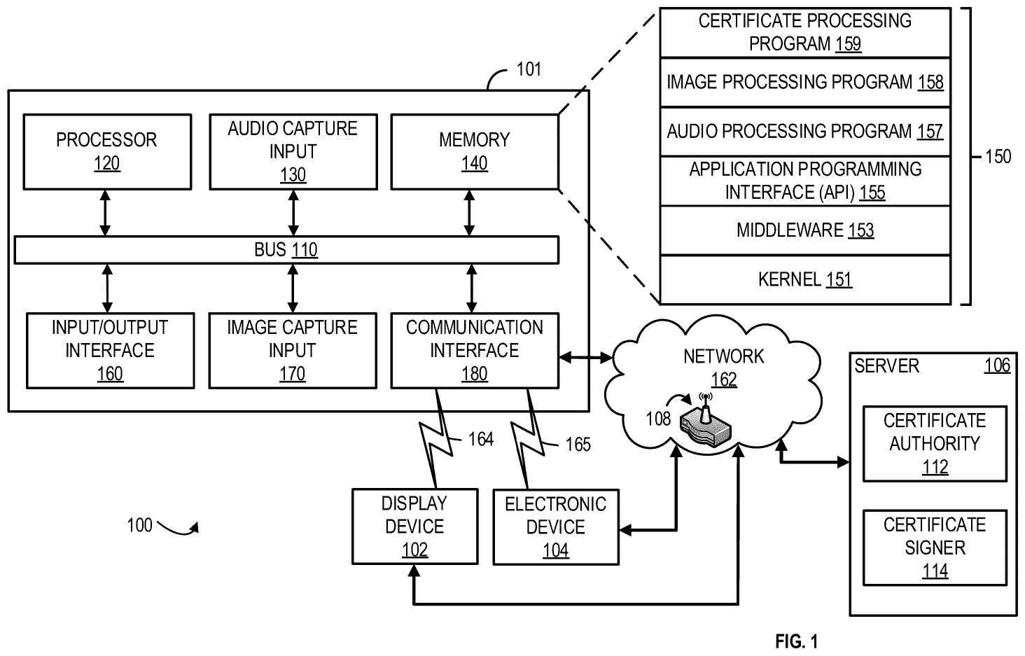

FIG. 1 shows an example system 100 for processing images and audio of a scene/environment, that may include a subject/individual, captured by a device (e.g., a data capture device 101). For example, the device may associate a motion threshold with the captured images of the scene/environment and an audio threshold with the captured audio of the scene/environment. A first length of time may be associated with the motion threshold and a second length of time may be associated with the audio threshold. The device may send an alert notification based on the motion threshold being exceeded for the first length of time and/or the audio threshold being exceeded for the second length of time. The system 100 may include a data capture device 101, a display device 102, a mobile device 104, one or more servers 106, and a network device 108. In an example, the data capture device 101 may be configured to capture audio and images (e.g., video feed, video stream, etc.) of a scene/environment that may include a subject/individual being monitored by the data capture device 101. In an example, the data capture device 101 may be configured to process the video feed in H.264 Advanced Video Coding (AVC), H.265 High Efficiency Video Coding (HEVC), and the like, and communicate the video feed via Web Real-Time Communication (WebRTC). In an example, the data capture device 101 may be in communication with the display device 102, the mobile device 104, and the one or more servers 106 via a network (e.g., network 162) provided by the network device 108.

The data capture device 101 may include a bus 110, one or more processors 120, an audio capture input 130, a memory 140, an input/output interface 160, an image capture input 170, and a communication interface 180. In certain examples, the data capture device 101 may omit at least one of the aforementioned elements or may additionally include other elements. The data capture device 101 may comprise an image sensor, a camera device, a smart camera, an infra-red sensor, a depth/motion-capture sensor (e.g., RGB-D camera), a LiDAR sensor, and the like. As an example, the data capture device 101 may include an image sensor, lens, and filter (e.g., IR filter extended/retracted, etc.). In an example, the data capture device 101 may include an image sensor (or a Wi-Fi enabled image sensor) and a microphone.

The bus 110 may comprise a circuit for connecting the bus 110, the one or more processors 120, the audio capture input 130, the memory 140, the input/output interface 160, the image capture input 170, and/or the communication interface 180 to each other and for delivering communication (e.g., a control message and/or data) between the bus 110, the one or more processors 120, the audio capture input 130, the memory 140, the input/output interface 160, the image capture input 170, and/or the communication interface 180.

The one or more processors 120 may include one or more of a Central Processing Unit (CPU), an Application Processor (AP), or a Communication Processor (CP). The one or more processors 120 may control, for example, at least one of the bus 110, the audio capture input 130, the memory 140, the input/output interface 160, the image capture input 170, and/or the communication interface 180 of the data capture device 101 and/or may execute an arithmetic operation or data processing for communication. For example, the one or more processors 120 may drive (e.g., cause) the audio capture input 130 and the image capture input 170, respectively to receive/capture audio of a scene/environment and one or more images (e.g., video stream). For example, a scene/environment may include a subject/individual (e.g., baby, child, adult, etc.) that may be monitored via the data capture device 101 based on audio and images captured via the audio capture input 130 and the image capture input 170, respectively. The processing (or controlling) operation of the one or more processors 120 according to various embodiments is described in detail with reference to the following drawings.

The processor-executable instructions executed by the one or more processors 120 may be stored and/or maintained by the memory 140. The memory 140 may include a volatile and/or non-volatile memory. The memory 140 may include random-access memory (RAM), flash memory, solid state or inertial disks, or any combination thereof. As an example, the memory 140 may include an Embedded MultiMedia Card (eMMC). The memory 140 may store, for example, a command or data related to at least one of the bus 110, the one or more processors 120, the audio capture input 130, the memory 140, the input/output interface 160, the image capture input 170, and/or the communication interface 180 of the data capture device 101. According to various examples, the memory 140 may store software and/or a program 150 or may comprise firmware. For example, the program 150 may include a kernel 151, a middleware 153, an Application Programming Interface (API) 155, an audio processing program 157, an image processing program 158, and/or a certificate processing program 159, and/or the like, configured for controlling one or more functions of the data capture device 101 and/or an external device (e.g., the display device 102 or electronic device 104). At least one part of the kernel 151, middleware 153, or API 155 may be referred to as an Operating System (OS). The memory 140 may include a computer-readable recording medium (e.g., a non-transitory computer-readable medium) having a program recorded therein to perform the methods according to various embodiments by the one or more processors 120. In an example, the memory 140 may store the recordings received from the image capture input 170, including the associated audio from the audio capture input 130.

The kernel 151 may control or manage, for example, system resources (e.g., the bus 110, the one or more processors 120, the memory 140, etc.) used to execute an operation or function implemented in other programs (e.g., the middleware 153, the API 155, the audio processing program 157, the image processing program 158, or certificate processing program 159). Further, the kernel 151 may provide an interface capable of controlling or managing the system resources by accessing individual elements of the data capture device 101 in the middleware 153, the API 155, the audio processing program 157, or image processing program 158, or the certificate processing program 159.

The middleware 153 may perform, for example, a mediation role, so that the API 155, the audio processing program 157, the image processing program 158, and/or the certificate processing program 159 can communicate with the kernel 151 to exchange data. Further, the middleware 153 may handle one or more task requests received from the audio processing program 157, the image processing program 158, and/or the certificate processing program 159 according to a priority. For example, the middleware 153 may assign a priority of using the system resources (e.g., the bus 110, the one or more processors 120, or the memory 140) of the data capture device 101 to at least one of the audio processing program 157, the image processing program 158, and/or the certificate processing program 159. For example, the middleware 153 may process the one or more task requests according to the priority assigned to at least one of the application programs, and thus, may perform scheduling or load balancing on the one or more task requests.

The API 155 may include at least one interface or function (e.g., instruction), for example, for file control, window control, video processing, and/or character control, as an interface capable of controlling a function provided by the audio processing program 157, the image processing program 158, and/or the certificate processing program 159 in the kernel 151 or the middleware 153.

As an example, the audio processing program 157, the image processing program 158, and the certificate processing program 159 may be independent of each other or integrally combined, in whole or in part.

The audio processing program 157 may include logic (e.g., hardware, software, firmware, etc.) that may be implemented to monitor the captured audio that may be received from the audio capture input 130. The audio capture input 130 may comprise a microphone or any device configured to capture audio of an environment, including audio associated with a subject/individual in the environment. The audio processing program 157 may be configured to consistently tune and update baseline audio settings for identifying an audio event. For example, audio associated with a decibel level above the baseline audio setting may be determined to satisfy a first requirement (e.g., a first audio threshold) of a plurality of requirements for sending an alert notification to one or more user devices (e.g., display device 102 and/or electronic device 104). The amount of decibels above the baseline audio setting may be user-programmable from a default setting. In an example, an amount of time the audio event continues may be determined to satisfy a second requirement (e.g., second audio threshold) of the plurality of requirements for sending the alert notification. As an example, the amount of time may be user programmable from a default setting. The system may determine a percentage of a time-period that must contain significant audio (e.g., audio above the baseline audio setting) in order to satisfy the second requirement. In an example, a third requirement (e.g., third audio threshold) may include additional parameters that the audio processing program 157 may tune over time via user feedback and automatically via a predictive learning model such as an artificial intelligence (AI) model and/or a machine learning (ML) model. For example, the additional audio parameters may comprise one or more of a type of sound in the audio (e.g., a frequency of the audio), a motion associated with the audio, a type of motion, a day of the week and time of the day, a location of system users (e.g., user devices), user-defined temporary application settings (e.g., away setting), or an amount of time since a previous alert notification. The alert notification may comprise an audio alert, a visual alert, and/or a haptic alert that may be communicated to one or more users via the one or more user devices (e.g., one or more display devices 102, one or more electronic devices 104, etc.). In an example, the alert notification sent to the one or more user devices may be configured to cause the one or more user devices to one or more of exit a standby mode, output the one or more images captured by the data capture device 101, output the audio captured by the data capture device 101, or emit a haptic output. In an example, the audio processing program 157 may be configured to send the alert notification directly to the one or more devices (e.g., display devices 102, electronic devices 104, etc.) in the event an Internet connection (e.g., via network 162) is interrupted. For example, the alert notification may be sent via connections 164, 165. Thus, the one or more devices (e.g., display device 102, electronic device 104, etc.) may still receive the alert notifications in the event the internet is interrupted. In an example, a plurality of user devices (e.g., display devices 102, electronic devices 104, etc.) may be in communication with the data capture devices 101. The audio processing program 157 may determine which user device of the plurality of user devices to send the alert notification. For example, the audio processing program 157 may determine which user device to send the alert notification based on a schedule.

As an example, the alert notification may cause one or more devices (e.g., display devices 102, electronic devices 104, etc.) to activate, or turn on, the audio of the one or more devices. For example, the devices (e.g., display devices 102, electronic devices 104, etc.) may be configured to activate, or enter into, a silent mode, if the devices have not received any alert notifications after a predetermined time or when initially activated. For example, baby monitoring devices usually output noise (e.g., static noise, white noise, background noise, etc.) even if no sound is detected in the room being monitored. By entering into a silent mode, the devices may be configured to discontinue any output of audio, including any noise or background noise, until an alert notification is received. The alert notification received from the data capture device 101 may cause the devices (e.g., display devices 102, electronic devices 104, etc.) to exit the silent mode and begin outputting the audio received from the data capture device 101.

As an example, the audio processing program 157 may include logic (e.g., hardware, software, firmware, etc.) that may be implemented to determine (e.g., detect) specific sounds (e.g., coughing, sneezing, wheezing, etc.) within the captured audio. For example, the audio processing program 157 may be implemented to cause the data capture device 101 to a likelihood of a medical condition (e.g., croup, etc.) associated with an individual associated with the captured audio based on the specific sounds. For example, the audio processing program 157 may utilize machine learning algorithms to determine the likelihood of the medical condition based on the specific sounds. In an example, the audio processing program 157 may cause the data capture device 101 to send the processed audio of the specific sounds to a server (e.g., server 106), wherein the server may determine the likelihood of the media condition based on the specific sounds. For example, the server may utilize machine learning algorithms to determine the likelihood of the medical condition based on the specific sounds. As an example, an alert notification may be sent to a third party server (e.g., a healthcare provider) and/or one or more user devices associated with one or more guardians of the individual associated with the determined medical condition.

The image processing program 158 may include logic (e.g., hardware, software, firmware, etc.) that may be implemented to monitor the captured images that may be received from the image capture input 170. The image capture input 170 may comprise an image sensor, a camera, an infra-red sensor, a depth/motion capture sensor (e.g., RGB-D camera), or any device configured to capture images/motion of a subject/individual in an environment. In an example, the data capture device 101 may be configured to process two feeds provided by the same camera (e.g., the same image capture input 170). For example, the data capture device 101 may be configured to create a view of the crib and a separate broader view of the room, both captured by the same camera (e.g., the same image capture input 170). In an example, the data capture device 101, via the image capture input 170, may be capable of low light image processing instead of using infrared (IR) lighting. This would allow the data capture device 101 to detect motion events without the use of IR lighting.

The image processing program 158 may be configured to process the captured images to determine whether to send an alert notification to the one or more user devices. The captured images may comprise video (e.g., video stream, video feed, etc.), of an environment, that may include a subject/individual in the environment. The image processing program 158 may be configured to consistently tune and update baseline motion settings for identifying a motion event. For example, motion associated with an amount of motion determined (e.g., detected) above the baseline motion setting may be determined to satisfy a first requirement (e.g., a first motion threshold) of a plurality of requirements for sending an alert notification to the one or more user devices (e.g., electronic device 104). The amount of motion above the baseline motion setting may be user-programmable from a default setting. In an example, a motion duration of the motion event may be determined to satisfy a second requirement (e.g., second motion threshold) of the plurality of requirements for sending the alert notification. As an example, the motion duration may be user programmable from a default setting. The system may determine a percentage of a time-period that must contain significant motion (e.g., motion above the baseline motion setting) in order to satisfy the second requirement. In an example, a third requirement (e.g., third motion threshold) may include additional motion parameters that the image processing program 158 may tune over time via user feedback and automatically via a predictive model such as an artificial intelligence (AI) model and/or a machine learning (ML) model. For example, the additional parameters may comprise one or more of a type of motion, facial recognition, light/brightness level, quality of the images, a detection zone, an ignore zone, a day of the week and time of the day, a location of one or more users (e.g., user devices), an application setting (e.g., away setting), an amount of time since a previous alert notification, and the like. For example, the image processing program 158 may be configured to distinguish between different motions such as whether an adult is walking in a room making noise instead of motion from a baby or child lying in bed. This information may be used to determine whether to ignore sending an alert notification due to just the detection of an adult in the room or a child/baby in a dangerous position.

In an example, the image processing program 158 may further process the captured images to determine one or more position events associated with the individual. For example, the one or more position events may be associated with one or more of a first time of a baby standing in the crib or one or more dangerous positions (e.g., positions that may cause or lead to serious bodily injury or loss-of-life). For example, the image processing program 158 may be configured to apply AI/ML to the captured images to determine the positioning of the individual and the one or more events, such as sounds/images of choking/gagging, a newborn being positioned face-down, a newborn with his/her face covered by an object, and/or a child attempting to crawl out of the crib.

In an example, the image processing program 158 may be configured to send the alert notification directly to the one or more devices (e.g., display device 102 and/or electronic device 104) in the event an Internet connection (e.g., via network 162) is interrupted. For example, the alert notification may be sent via connections 164, 165. Thus, the one or more devices (e.g., display device 102 and/or electronic device 104) may still receive the alert notifications in the event the Internet connection is interrupted. In an example, the alert notification sent to the one or more devices (e.g., display device 102 and/or electronic device 104) may be configured to cause the one or more devices (e.g., display device 102 and/or electronic device 104) to one or more of exit a standby mode, output the one or more images captured by the data capture device 101, output the audio captured by the data capture device 101, or emit a haptic output. In an example, a plurality of devices (e.g., display device 102 and/or electronic device 104) may be in communication with the data capture devices 101. The image processing program 158 may determine which device of the plurality of user devices to send the alert notification. For example, the image processing program 158 may determine which user device to send the alert notification based on a schedule.

In an example, the audio processing program 157 and/or the image processing program 158 may be configured to be bypassed (e.g., via an override) based on one or more images of the subject indicating that a motion threshold has not been exceeded for a first length of time and/or based on the audio of the subject indicating that an audio threshold has not been exceeded for a second length of time. For example, based on determining (e.g., detecting) that audio, motion, or positioning of the subject indicates one or more position events associated with the subject/individual, the audio processing program 157 and/or the image processing program 158 may withhold sending the alert notifications. The one or more position events may be associated with a first time of a baby standing in the crib or one or more dangerous positions (e.g., positions that may cause or lead to serious bodily injury or loss-of-life). For example, the audio processing program 157 and/or the image processing program 158 may classify the audio and/or one or more images for determining that an override event is occurring. For example, the audio processing program 157 and/or the image processing program 158 may determine that an override event is occurring based on identifying, in the audio and/or one or more images, one or more of the subject is experiencing a motion event for a first time (e.g., baby walking for the first time), a sound of choking, a sound of gagging, the subject lying face-down, the subject's face covered by an object, or the subject attempting to crawl/climb out of a crib.

The certificate processing program 159 may include logic (e.g., hardware, software, firmware, etc.) that may be implemented to cause the data capture device 101 to generate and issue a Certificate Signing Request (CSR). For example, the data capture device 101 may send a CSR, via the network 162, to a certificate authority (CA) in order to receive a device-specific certificate signed by a certificate signer under the authority of a respective intermediate CA. For example, the CA may generate intermediate CAs by utilizing a 4096-bit RSA key, wherein each intermediate CA may be associated with a certificate signer. The certificate received by the data capture device 101 may comprise a x509 certificate. As an example, the certificates (e.g., root, intermediate and device certificates) may be self-signed without reliance on external CAs. The certificate received by the data capture device 101 may be used to verify the authenticity of the data capture device 101, or user of the data capture device 101.

The input/output interface 160 may include an interface for delivering an instruction or data input from a user (e.g., an operator of the data capture device 101) or from a different external device (e.g., electronic device 104) to the different elements of the data capture device 101. Further, the input/output interface 160 may output an instruction or data received from one or more elements of the data capture device 101 to one or more external devices (e.g., display device 102 or electronic device 104).

The communication interface 180 may establish, for example, communication between the data capture device 101 and one or more external devices (e.g., the display device 102, the electronic device 104, or the server 106). For example, the communication interface 180 may communicate with the one or more external devices (e.g., the display device 102, the electronic device 104, and/or the server 106) by being connected to a network 162 through wireless communication or wired communication. The network 162 may include, for example, at least one of a telecommunications network, a computer network (e.g., LAN or WAN), the Internet, and/or a telephone network.

The communication interface 180 may be configured to communicate with the one or more external devices (e.g., display device 102, or electronic device 104) via a wired communication interface 164, 165 or a wireless communication interface 164, 165. In an example, the wired communication may include, for example, at least one of Universal Serial Bus (USB), High Definition Multimedia Interface (HDMI), Recommended Standard-232 (RS-232), power-line communication, Plain Old Telephone Service (POTS), and the like. In an example, as a cellular communication protocol, the wireless communication interface 164, 165 may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the wireless communication interface 164, 165 may be configured to use a near-distance communication 164, 165. The near-distance communication interface 164, 165 may include for example, at least one of Wireless Fidelity (WiFi), Bluetooth, Bluetooth Low Energy (BLE), Near Field Communication (NFC), Global Navigation Satellite System (GNSS), and the like. According to a usage region or a bandwidth or the like, the GNSS may include, for example, at least one of Global Positioning System (GPS), Global Navigation Satellite System (GLONASS), BeiDou Navigation Satellite System (BDS), Galileo, the European global satellite-based navigation system, and the like. Hereinafter, the “GPS” and the “GNSS” may be used interchangeably in the present document. In an example, the communication interface 180 may include or be communicably coupled to a transmitter, receiver and/or transceiver for communication with the external devices (e.g., display device 102, or electronic device 104).

The display device 102 may comprise one or more of a television, an audio/video monitor, a streaming device, and the like. The display device 102 may include various types of displays, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. In an example, the display device 102 may be configured as a part of the data capture device 101 or as a separate device. In an example, the display device 102 may include audio output devices (e.g., speakers) for outputting the audio received from the data capture device 101. In an example, the display device 102 may be in communication with earphones (e.g., noise canceling earphones) so that when audio is played after receiving an alert notification, a single user is alerted audibly instead of playing the audio via the display device's 102 speakers. The display device 102 may display, for example, a variety of contents (e.g., text, image, video, icons, symbols, etc.) to the user. For example, the display device 102 may be configured to output the alert notification for display to a user of the display device 102. For example, the alert notification may include an indication that the subject/individual being monitored by the data capture device 101 is in a dangerous position, such as laying face-down or face covered by an object, or experiencing a dangerous, such as choking or attempting to crawl out of a crib.

In an example, the alert notifications may be sent by/from the data capture device 101 to the display device 102 via User Datagram Protocol (UDP) and may be completely localized such as via a wired connection (e.g., connection 164) or a network connection (e.g., network 162) via a network device (e.g., network device 108). The display device 102 may be configured to turn on (e.g., wake-up) when it receives the alert notification from the data capture device 101. For example, the display device 102 may be configured to activate the audio output device and the display screen when it receives the alert notification. In an example, the display device 102 may be configured to activate, or enter into, a silent mode if it hasn't received any alert notifications after a predetermined time or when initially activated. For example, baby monitoring devices usually output noise (e.g., static noise, white noise, background noise, etc.) even if no sound is detected in the room being monitored. By entering into a silent mode, the display device 102 may be configured to discontinue any output of audio, including any noise or background noise, until an alert notification is received. The alert notification received from the data capture device 101 may cause the display device 102 to exit the silent mode and begin outputting the audio received from the data capture device 101.

In an example, the display device 102 may be configured to wake-up for a user-defined amount of time and at a user-defined brightness level. These settings may be adjusted from a default setting. The display device 102 may be configured, or programmed, to not turn on the video/image, and instead display an animation, such as at nighttime, in order to prevent a user whose eyes have adapted to the dark from being introduced to significant light from the screen of the display device 102.

In an example, the display device 102 may be configured to be used as a digital picture frame when not in use for receiving the image/audio stream from the data capture device 101. For example, the display device 102 may be configured to receive photos from one or more user devices (e.g., electronic devices 104, server 106, etc.) and store the photos on the display device 102. The display device 102 may be configured/programmed to rotate the stored photos periodically displayed on the screen of the display device 102.

The electronic device 104 may comprise, for example, a laptop computer, a mobile phone, a smart phone, a tablet computer, a wearable device, a smartwatch, a haptic device, a desktop computer, a smart television, and the like. In an example, the electronic device 104 may comprise a plurality of user devices that may be authorized for accessing the image and audio (e.g., video stream/feed) from the data capture device 101. In an example, the electronic device 104 may be configured to use a mobile application for communicating with the data capture device 101. The electronic device 104 may receive the alert notifications from the data capture device 101 based on a location of the electronic device 104. For example, the alert notifications may be communicated to the electronic device 104 via WiFi LAN (e.g., network 162) or via remote servers (e.g., server 106) based on the location of the electronic device 104. The alert notifications may be received by the electronic device 104 via push notifications, SMS messages, emails, and/or automated phone-call notifications. The output of the alert notifications may be based on one or more user specifications and/or user preferences. For example, when the electronic device 104 receives an alert notification, based on user specifications and/or preferences, the electronic device 104 may output the audio from the data capture device 101 in the background on the electronic device 104. For example, the video feed received from the data capture device 101 may be output via a widget residing on a main lock screen of the electronic device 104. For example, the electronic device 104 may be configured to output the video as a picture-in-picture (PIP) on the screen of the electronic device 104. For example, when the alert notification is received, the electronic device 104 may highlight a specific data capture device, if more than one data capture device is in communication with the electronic device 104, that is sending the alert notification and output the alert notification to the user. In an example, the electronic device 104 may be in communication with an additional external electronic device such as a smart watch or other wearable device. The external electronic device may be configured to output the video feed and alert notifications to the user via the smart watch or the other wearable device.

In an example, the electronic device 104 may be configured to turn on (e.g., wake-up) when it receives the alert notification from the data capture device 101. For example, the electronic device 104 may be configured to activate an audio output device (e.g., speaker, earphones, etc.) of the electronic device 104 and a display screen when it receives the alert notification. In an example, the electronic device 104 may be configured to activate, or enter into, a silent mode if it hasn't received any alert notifications after a predetermined time or when initially activated. For example, baby monitoring devices usually output noise (e.g., static noise, white noise, background noise, etc.) even if no sound is detected in the room being monitored. By entering into a silent mode, the electronic device 104 may be configured to discontinue any output of audio, including any noise or background noise, until an alert notification is received. The alert notification received from the data capture device 101 may cause the electronic device 104 to exit the silent mode and begin outputting the audio received from the data capture device 101.

In an example, in the event that the data capture device 101 is unable to connect to the network (e.g., network 162) via a network device (e.g., network device 108) and is unable to establish a communication with the display device 102, the electronic device 104 may receive an alert notification of the inability to connect to the network or establish communication with the display device 102. The electronic device 104 may receive a second alert when the data capture device reconnects to the network.

In an example, only authorized users, or user devices (e.g., one or more electronic devices 104) may be allowed to connect to the data capture device 101, or plurality of data capture devices 101, connected to the network (e.g., network 162). For example, a user may log into a mobile application on the electronic device 104 by providing user identifying information, or user credentials, in order to access one or more data capture devices 101 that may be connected to the system 100. One or more levels of user permissions may be provided to the user based on the status of the user that is logged into the mobile application. For example, the status of the user may comprise a parent, baby-sitter, nanny, family member, friend, and the like. As an example, the parents (e.g., primary users) of the system 100, via the mobile application, may be given overall access to the system, including access to settings for what can be accessed (e.g., which data capture devices 101) and by whom (e.g., baby-sitter, nanny, family member, friend, etc.).

In an example, the parents, via the mobile application, may provide temporary access to one or more users. For example, the temporary users may receive permissions to perform one or more actions by the parents such as local-only or local and remote access, utilization of specific data capture devices, scheduling and start/end dates, live-only or historical views, and/or care team interaction. Temporary users may also be granted short-term permissions that alert the system 100 when it is soon to expire, allowing the parents to decide whether to extend or terminate the short-term permissions. In an example, the parents, via the mobile application, may be able to immediately pause shared access to all temporary users for a temporary period of time in the event that they need to ensure privacy quickly. The parents, via the mobile application, may also be able to mark time-periods in the historical view as private moments in order to prevent temporary users from seeing the private moment.

In an example, the parents, via the mobile application, may grant specific permissions for professional care, or on-demand services, such as remote sleep coaches, pediatricians, mental health professionals, lactation consulting professionals, and the like.

For example, remote sleep coaches may be granted access to tune the alert thresholds and monitor multiple children/individuals via specific feeds provided to the system 100 via one or more data capture devices 101. The remote sleep coaches may also send an alert notification to the parent's mobile application and interact with the parents through the parent's electronic device 104. In an example, the parents, via the mobile application, may access telemedicine services including scheduling appointments, receiving reminder notifications of appointments, video calls with a provider, providing/receiving patient information, and/or viewing history of appointments and provider notes.

The server 106 may include a group of one or more servers. For example, all or some of the operations executed by the data capture device 101 may be executed in a different one or a plurality of electronic devices (e.g., the display device 102, the electronic device 104, and/or the server 106). In an example, if the data capture device 101 needs to perform a certain function or service either automatically or based on a request, the data capture device 101 may request at least some parts of functions related thereto alternatively or additionally to a different electronic device (e.g., the display device 102, the electronic device 104 and/or the server 106) instead of executing the function or the service autonomously. The different electronic devices (e.g., the display device 102, the electronic device 104, or the server 106) may execute the requested function or additional function, and may deliver a result thereof to the data capture device 101. The data capture device 101 may provide the requested function or service either directly or by additionally processing the received result. For example, a cloud computing, distributed computing, or client-server computing technique may be used.

In an example, the server 106 may be configured to verify an authenticity of one or more data capture devices 101 in order to mitigate risks associated with “man-in-the-middle” attacks or device impersonations. For example, the server 106 may include a certificate authority 112 and one or more certificate signers 114. The certificate authority 112 and the one or more certificate signers 114 may be implemented as devices/components/modules integrated with the server 106 or as separate and independent devices. The certificate authority 112 may be configured to utilize a 4096-bit RSA key to generate one or more intermediate certificate authorities (CA). Each certificate signer 114 of the one or more certificate signers 114 may be associated with an intermediate CA. The server 106 may receive a Certificate Signing Request (CSR) from the data capture device 106 and send a device-specific certificate signed by the certificate signer 114 associated with the respective intermediate CA. The device specific certificate may comprise a x509 certificate. The server 106 may store each certificate signed by the intermediate CA.

The network device 108 may facilitate the connection of a device (e.g., data capture device 102, display device 102, electronic device 106) to the network 162. As an example, the network device 108 may be configured as a set-top box, a gateway device, an access point device, or wireless access point (WAP). In an example, the network device 108 may be configured to allow one or more wireless devices to connect to a wired and/or wireless network using Wi-Fi, Bluetooth®, Zigbee®, or any desired method or standard. In an example, the network device 108 may be configured as a local area network (LAN). The network device 108 may be a dual band wireless access point. The network device 108 may be configured with a first service set identifier (SSID) (e.g., associated with a user network or private network) to function as a local network for a particular user or users. The network device 108 may be configured with a second service set identifier (SSID) (e.g., associated with a public/community network or a hidden network) to function as a secondary network or redundant network for connected communication devices. The network device 108 may comprise an identifier. As an example, the identifier may be or relate to an Internet Protocol (IP) Address (e.g., IPV4/IPV6) or a media access control address (MAC address) or the like. As an example, the identifier may be a unique identifier for facilitating communications on the physical network segment. As an example, the identifier may be associated with a physical location of the network device 108.

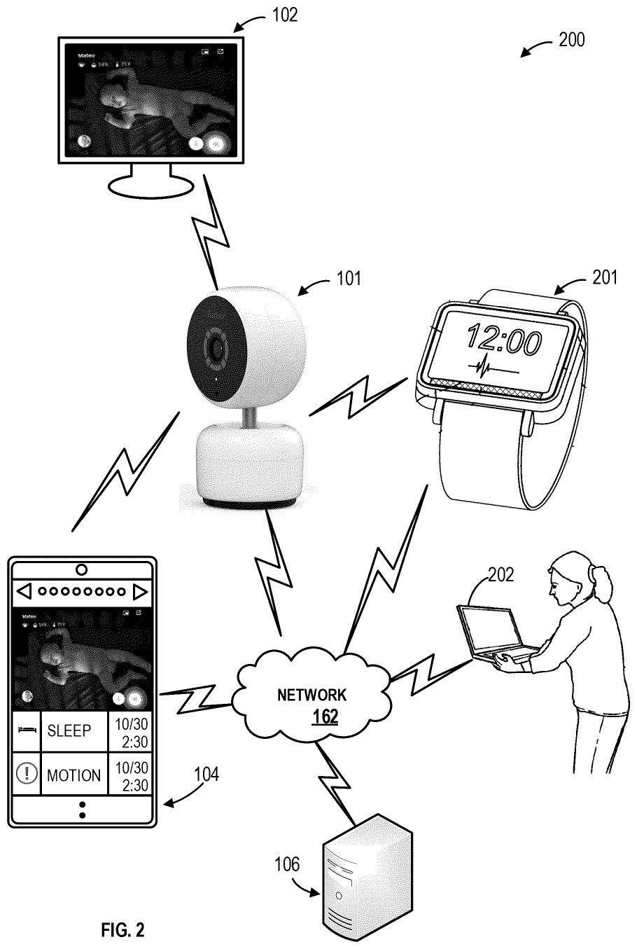

FIG. 2 shows an example system environment 200. The system 200 may comprise a data capture device 101 (e.g., camera device, smart camera, infra-red sensor, depth/motion capture sensor (e.g., RGB-D camera), LiDAR sensor, etc.), a display device 102 (e.g., television, audio/video monitor, streaming device, etc.), an electronic device 104 (e.g., laptop computer, mobile phone, smart phone, tablet computer, desktop computer, etc.), a wearable device 201 (e.g., smartwatch, haptic device, etc.), a computing device 202 (e.g., laptop computer, mobile phone, smart phone, tablet computer, desktop computer, etc.), and a server 106 in communication with each other via a network 162, such as a WiFi network or cellular network. The data capture device 101 may be configured to send one or more alert notifications to one or more of the display device 102, the electronic device 104, the wearable device 201, and/or the computing device 202. In an example, the data capture device 101 may be configured to send data to the server 106. For example, the server 106 may receive and store one or more video streams and/or audio and one or more alert notifications received from the data capture device 101.

In an example, authorized users, or user devices (e.g., one or more electronic devices 104, one or more wearable devices 201, one or more computing devices 202) may be allowed to connect to, or access, the data capture device 101, or plurality of data capture devices 101, connected to the network (e.g., network 162). For example, a user may log into a mobile application on the electronic device 104 by providing user identifying information, or user credentials, in order to access one or more data capture devices 101 that may be connected to the network 162. One or more levels of user permissions may be provided to the user based on the status of the user that is logged into the mobile application. For example, the status of the user may comprise a parent, baby-sitter, nanny, family member, friend, and the like. As an example, the parents (e.g., primary users) of the system 200, via the mobile application, may be given overall access to the system, including access to settings for what can be accessed (e.g., which data capture devices 101) and by whom (e.g., baby-sitter, nanny, family member, friend, etc.).

The data capture device 101 may send the video streams to the display device 102, electronic device 104, the wearable device 201, and the computing device 202. In an example, the alert notifications may be sent by/from the data capture device 101 to the display device 102 via User Datagram Protocol (UDP) and may be completely localized such as via a wired connection or a network connection (e.g., network 162). In an example, if the data capture device 101 disconnects from the network 162, it may be configured to attempt to communicate with the display device 102 via another connection such as a wired connection. If the data capture device 101 cannot connect to the display device 102, the electronic device 104, the wearable device 201, and/or the computing device 202 may receive an alert notification of the inability to connect to the display device 102. The electronic device 104, the wearable device 201, and/or the computing device 202 may receive a second alert when the data capture device 101 reconnects to the network 162. The display device 102, the electronic device 104, the wearable device 201, and the computing device 202 may each be configured to output both the video feed and the alert notifications received from the data capture device 101. In an example, the electronic device 104, the wearable device 201, and the computing device 202 may be configured to output the alert notifications and/or other notifications as an overlay or on a separate portion of the screen concurrently with the video feed from the data capture device 101.

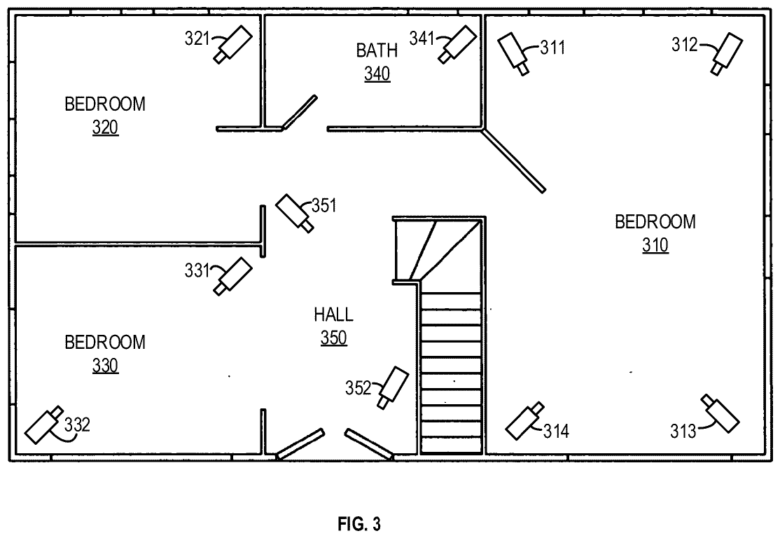

FIG. 3 shows an example system environment 300. The system 300 may comprise a plurality of data capture devices 311-314, 321, 331-332, 341, and 351-352 placed in one or more rooms/areas 310, 320, 330, 340, and 350 of a home. For example, as shown in FIG. 3, bedroom 310 may include data capture devices 311-314, bedroom 320 may include data capture device 321, bedroom 330 may include data capture devices 331-332, bathroom 340 may include data capture device 341, and hallway 350 may include data capture devices 351-352. One or more electronic devices may be in communication with the plurality of data capture devices 311-314, 321, 331-332, 341, 351-352 for receiving the video feeds and alert notifications from the plurality of data capture devices 311-314, 321, 331-332, 341, 351-352.

In an example, a primary user, via a mobile application, may provide access to the data capture devices 311-314, 321, 331-332, 341, 351-352 to professional care, or on-demand services, such as remote sleep coaches, pediatricians, mental health professionals, lactation consulting professionals, and the like. A professional service person, via the mobile application, may be granted access to tune the alert thresholds and monitor multiple children via specific feeds provided to the system 300 via the data capture devices 311-314, 321, 331-332, 341, 351-352. The professional service person may also send an alert to the primary user's mobile application and interact with the primary user through the primary user's electronic device. In an example, the primary user, via the mobile application, may restrict access to one or more of the data capture devices. For example, each data capture device may be associated with a unique identifier and a location of the data capture device. For example, bedroom 320 may comprise the primary user's bedroom, which the primary user may wish to retain privacy as to the contents of the bedroom. Thus, the primary user, via the mobile application, may restrict access to the data capture device 321 in bedroom 320 to any other user (e.g., temporary users) that may have been access to the video feeds in the primary user's home.

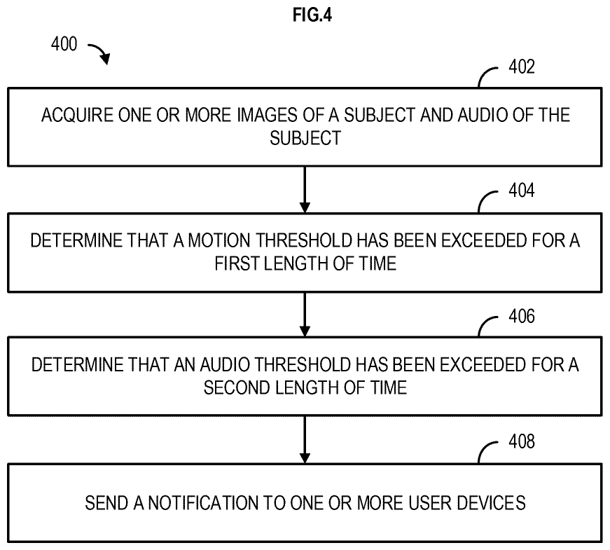

FIG. 4 shows a flowchart of an example method 400 for monitoring a scene captured by a data capture device. Method 400 may be implemented by one or more of the data capture device 101, the display device 102, the electronic device 104, the server 106, any other suitable device, or any combination thereof. At step 402, one or more images of a subject and audio of a subject may be acquired via a data capture device. The data capture device may comprise an image sensor and a microphone. For example, the data capture device may comprise one or more of a camera device, a smart camera, an infra-red sensor, a depth/motion-capture sensor (e.g., RGB-D camera), a LiDAR sensor, and the like. The one or more images, including the audio, may comprise video of the subject.

At step 404, it may be determined that a motion threshold has been exceeded for a first length of time. The motion threshold may comprise an amount of motion. For example, motion associated with an amount of motion determined (e.g., detected) above a baseline motion setting (e.g., motion threshold) may be determined to satisfy a requirement for sending an alert notification to one or more user devices. The first length of time may comprise a user-programmable length of time. For example, the amount of motion that exceeds the motion threshold may be a user-programmable setting. In an example, the data capture device may determine a percentage of the first length of time that must contain significant motion (e.g., motion threshold being exceeded) in order to send a notification.

At step 406, it may be determined that an audio threshold has been exceeded for a second length of time. The audio threshold may comprise a decibel level. For example, audio associated with a decibel level above a baseline audio setting (e.g., audio threshold) may be determined to satisfy a requirement for sending an alert notification to one or more user devices. The second length of time may comprise a user-programmable length of time. For example, the amount of decibels that exceeds the audio threshold may be a user-programmable setting. The second length of time may be different than the first length of time. In an example, the data capture device may determine a percentage of the second length of time that must contain significant audio (e.g., audio threshold being exceeded) in order to send a notification.

At step 408, a notification may be sent to one or more user devices based on the motion threshold being exceeded for the first length of time and the audio threshold being exceeded for the second length of time. In an example, the data capture device may send the notification via the local area network to the one or more user devices based on the motion threshold being exceeded for the first length of time and the audio threshold being exceeded for the second length of time. The one or more user devices may comprise one or more of a smartwatch, a haptic device, an audio/video monitor, a smartphone, a computer, a television, a set-top box, or a streaming device. In an example, sending the notification to the one or more user devices may cause the one or more user devices to one or more of exit a standby mode, output the one or more images, output the audio, or emit a haptic output. In an example, the one or more devices may be determined to receive the notification based on a schedule. In an example, a user device of the one or more user devices may be determined to receive the notification of the alert event.

In an example, an indication from the one or more user devices that the notification is indicative of an alert event may be received. One or more notification parameters associated with the alert event may be determined based on the alert event. A predictive model (e.g., machine learning model, artificial intelligence, etc.) configured for predicting a likelihood that an alert event is occurring may be trained based on the one or more notification parameters. The one or more notification parameters may comprise one or more of a type of sound in the audio, motion associated with the audio, a type of motion, facial recognition, a light level, a quality of image, a detection zone, an ignore zone, a day of week, a time of day, a location of one or more users, an application setting, an amount of time since a previous notification, and the like.

As an example, the data capture device may be configured to distinguish between different motions such as whether an adult is walking in a room making noise instead of motion from a baby or child lying in bed. This information may be used to determine whether to ignore sending an alert notification due to just the detection of an adult in the room or a child/baby in a dangerous position. For example, one or more position events associated with an individual monitored by the data capture device may be determined. The one or more position events may be associated with one or more of first time of a baby standing in the crib or one or more dangerous position (e.g., positions that may cause or lead to serious bodily injury or loss-of-life). The data capture device may apply the predictive model to the captured images to determine the positioning of the individual and the one or more events, such as sounds/images of choking/gagging, a newborn being positioned face-down, a newborn with his/her face covered by an object, and/or a child attempting to crawl out of the crib.

In an example, one or more values of the one or more notification parameters may be determined based on one or more of the one or more images or the audio. The one or more values of the one or more notification parameters may be provided to a predictive model (e.g., machine learning model, artificial intelligence, etc.) configured for predicting a likelihood that an alert event is occurring. The notification may be sent, via the local area network, to the one or more user devices based on receipt, from the predictive model, of the likelihood that an alert event is occurring, wherein the likelihood that the alert event is occurring exceeds an event threshold.

In an example, it may be determined that the data capture device is not in communication with the local area network. A direct communication link may be established with the one or more user devices based on the data capture device not being in communication with the local area network. For example, the notification may be sent to the one or more user devices via one or more of a cellular network, a near-distance communication network, a wired connection, and the like.

In an example, the data capture device may establish a communication session with a remote computing device. The one or more images and audio may be received by the remote computing device via the communication session. The remote computing device may output the one or more images and the audio, may receive an input indicative of the alert event, and may send a notification indicative of the alert event.

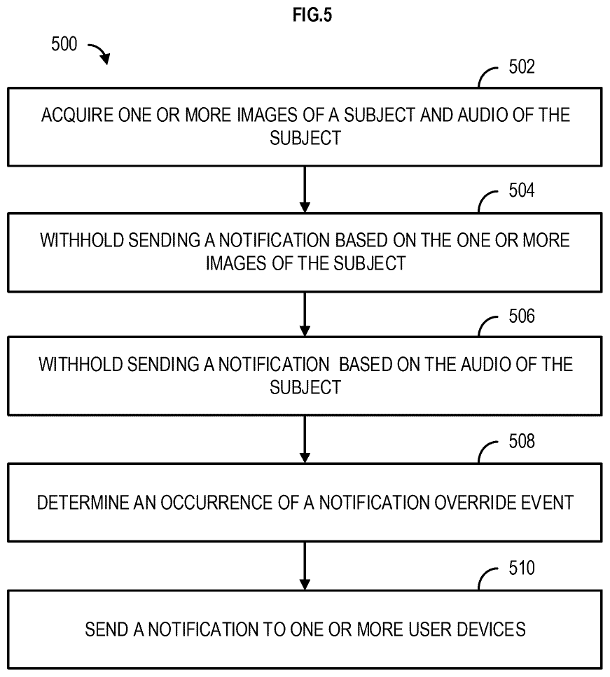

FIG. 5 shows a flowchart of an example method 500 for monitoring a scene captured by a data capture device. Method 500 may be implemented by one or more of the data capture device 101, the display device 102, the electronic device 104, the server 106, any other suitable device, or any combination thereof. At step 502, one or more images of a subject and audio of the subject may be acquired via a data capture device. The data capture device may comprise an image sensor and a microphone. For example, the data capture device may comprise one or more of a camera device, a smart camera, an infra-red sensor, a depth/motion capture sensor (e.g., RGB-D camera), a LiDAR sensor, and the like. The one or images, including the audio, may comprise video of the subject.

At step 504, a notification may be withheld from being sent based on the one or more images of the subject indicating that a motion threshold has not been exceeded for a first length of time. As an example, the motion threshold may comprise a threshold amount of motion (e.g., a maximum amount of motion or a minimum amount of motion). For example, motion associated with an amount of motion determined (e.g., detected) above a baseline motion setting (e.g., motion threshold, type of motion, etc.) may be determined to satisfy a requirement for withhold sending an alert notification to one or more user devices. As an example, the first length of time may comprise a user-programmable length of time. For example, the amount of motion that exceeds the motion threshold may be a user-programmable setting. In an example, the data capture device may determine a percentage of the first length of time that must contain significant motion (e.g., motion threshold being exceeded, type of motion, etc.).

At step 506, a notification may be withheld from being sent based on the audio of the subject indicating that an audio threshold has not been exceeded for a second length of time. As an example, the audio threshold may comprise a threshold decibel level (e.g., maximum decibel level or minimum decibel level). For example, audio associated with a decibel level above a baseline audio setting (e.g., audio threshold, type of audio, etc.) may be determined to satisfy a requirement for sending an alert notification to one or more user devices. As an example, the second length of time may comprise a user-programmable length of time. For example, the amount of decibels that exceeds the audio threshold may be a user-programmable setting. The second length of time may be different than the first length of time. In an example, the data capture device may determine a percentage of the second length of time that must contain significant audio (e.g., audio threshold being exceeded, type of audio, etc.).

At step 508, an occurrence of a notification override event may be determined based on the one or more images or the audio. The notification override event may be indicative of the subject experiencing one or more position events. For example, the one or more position events may be associated with a first time of a baby standing in the crib or one or more dangerous positions (e.g., positions that may cause or lead to serious bodily injury or loss-of-life). In an example, the one or more images or the audio may be classified by a predictive model (e.g., machine learning model, artificial intelligence, etc.) configured for predicting a likelihood that a notification override event is occurring. For example, the notification override event may be determined based on identifying in the audio and/or one or more images one or more of a sound of choking, a sound of gagging, the subject lying face-down, the subject's face covered by an object, or the subject attempting to crawl out of a crib.

At step 510, a notification to one or more user devices may be sent via a local area network based on the notification override event. The one or more user devices may comprise one or more of a smartwatch, a haptic device, an audio/video monitor, a smartphone, a computer, a television, a set-top box, or a streaming device. In an example, sending the notification to the one or more user devices may cause the one or more user devices to one or more of exit a standby mode, output the one or more images, output the audio, or emit a haptic output. In an example, the one or more devices may be determined to receive the notification based on a schedule.

In an example, an indication may be received from the one or more user devices that the notification is indicative of a notification override event. One or more notification parameters associated with the notification override event may be determined based on the notification override event. The predictive model may be trained based on the one or more notification parameters. The predictive model may be configured to output a prediction indicative of a likelihood that a notification override event is occurring. The one or more notification parameters may comprise one or more of a sound of choking, a sound of gagging, the subject lying face-down, the subject's face covered by an object, or the subject attempting to crawl out of a crib.

As an example, the occurrence of the notification override event may be determined based on one or more values of the one or more notification parameters. For example, the one or more values of the one or more notification parameters may be determined and provided to the predictive model. The predictive model may determine the likelihood that a notification override event is occurring. The notification may be sent, via the local area network, to the one or more user devices based on receipt, from the predictive model, of the likelihood that a notification override event is occurring, wherein the likelihood that the notification override event is occurring exceeds an override event threshold.

In an example, it may be determined that the data capture device is not in communication with the local area network. A direct communication link may be established with the one or more user devices based on the data capture device not being in communication with the local area network. For example, the notification may be sent to the one or more user devices via one or more of a cellular network, a near-distance communication network, a wired connection, and the like.

In an example, the data capture device may establish a communication session with a remote computing device. The one or more images and audio may be received by the remote computing device via the communication session. The remote computing device may output the one or more images and the audio, may receive an input indicative of the notification override event, and may send a notification indicative of the notification override event. In an example, a user device of the one or more user devices may be determined to receive the notification of the notification override event.

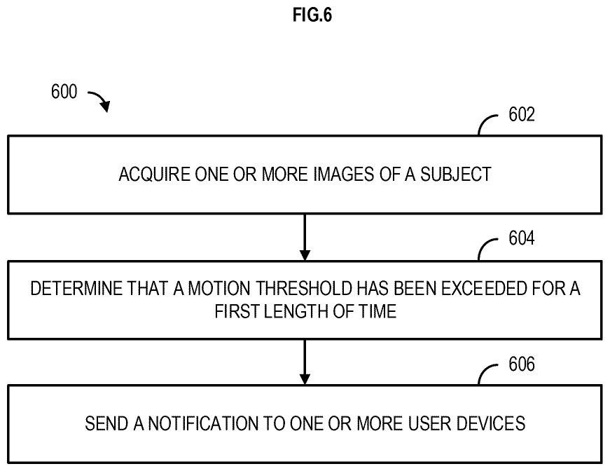

FIG. 6 shows a flowchart of an example method 600 for monitoring a scene captured by a data capture device. Method 600 may be implemented by one or more of the data capture device 101, the display device 102, the electronic device 104, the server 106, any other suitable device, or any combination thereof. At step 602, one or more images of a subject may be acquired via a data capture device. The data capture device may comprise an image sensor. For example, the data capture device may comprise one or more of a camera device, a smart camera, an infra-red sensor, a depth/motion capture sensor (e.g., RGB-D camera), a LiDAR sensor, and the like. The one or images may comprise video of the subject.

At step 604, it may be determined that a motion threshold has been exceeded for a first length of time based on the one or more images of the subject. The motion threshold may comprise a threshold amount of motion (e.g., maximum amount of motion or minimum amount of motion). For example, motion associated with an amount of motion determined (e.g., detected) above a baseline motion setting (e.g., motion threshold) may be determined to satisfy a requirement for sending an alert notification to one or more user devices. The first length of time may comprise a user-programmable length of time. For example, the amount of motion that exceeds the motion threshold may be a user-programmable setting. In an example, the data capture device may determine a percentage of the first length of time that must contain significant motion (e.g., motion threshold being exceeded).

At step 606, a notification may be sent, via a local area network, to one or more user devices based on the motion threshold being exceeded for the first length of time. The one or more user devices may comprise one or more of a smartwatch, a haptic device, an audio/video monitor, a smartphone, a computer, a television, a set-top box, or a streaming device. In an example, sending the notification to the one or more user devices may cause the one or more user devices to one or more of exit a standby mode, output the one or more images, output the audio, or emit a haptic output. In an example, the one or more devices may be determined to receive the notification based on a schedule.

As an example, one or more values of one or more notification parameters may be determined. The one or more values of the one or more notification parameters may be provided to a predictive model (e.g., machine learning model, artificial intelligence, etc.) configured for predicting a likelihood that an alert event is occurring. The notification may be sent, via the local area network, to the one or more user devices based on receipt, from the predictive model, of the likelihood that an alert event is occurring, wherein the likelihood that the alert event is occurring exceeds an event threshold. The one or more notification parameters may comprise one or more of a type of sound in an audio, motion associated with an audio, a type of motion, facial recognition a light level, a quality of image, a detection zone, an ignore zone, a day of week, a time of day, a location of one or more users, an application setting, an amount of time since a previous notification, and the like.

As an example, the data capture device may also acquire audio of the subject. For example, the data capture device may further comprise a microphone. It may be determined that an audio threshold has been exceeded for a second length of time. The audio threshold may comprise a threshold decibel level (e.g., maximum decibel level or minimum decibel level). For example, audio associated with a decibel level above a baseline audio setting (e.g., audio threshold) may be determined to satisfy a requirement for sending an alert notification to one or more user devices. The second length of time may comprise a user-programmable length of time. For example, the amount of decibels that exceeds the audio threshold may be a user-programmable setting. The second length of time may be different than the first length of time. In an example, the data capture device may determine a percentage of the second length of time that must contain significant audio (e.g., audio threshold being exceeded). The notification may be sent, via the local area network, to one or more user devices based on the audio threshold being exceeded for the second length of time.

As an example, an indication from the one or more user devices that the notification is indicative of an alert event may be received. One or more notification parameters associated with the alert event may be determined based on the alert event. A predictive model (e.g., machine learning model, artificial intelligence, etc.) configured for predicting a likelihood that an alert event is occurring may be trained based on the one or more notification parameters. The one or more notification parameters may comprise one or more of a type of sound in the audio, motion associated with the audio, a type of motion, facial recognition, a light level, a quality of image, a detection zone, an ignore zone, a day of week, a time of day, a location of one or more users, an application setting, an amount of time since a previous notification, and the like.

As an example, it may be determined that the data capture device is not in communication with the local area network. A direct communication link may be established with the one or more user devices based on the data capture device not being in communication with the local area network. For example, the notification may be sent to the one or more user devices via one or more of a cellular network, a near-distance communication network, a wired connection, and the like.

As an example, the data capture device may establish a communication session with a remote computing device. The one or more images and audio may be received by the remote computing device via the communication session. The remote computing device may output the one or more images and the audio, may receive an input indicative of the alert event, and may send a notification indicative of the alert event. In an example, a user device of the one or more user devices may be determined to receive the notification indicative of the alert event.

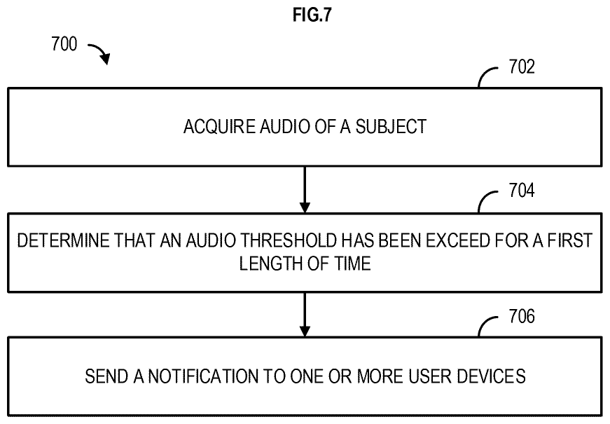

FIG. 7 shows a flowchart of an example method 700 for monitoring a scene captured by a data capture device. Method 700 may be implemented by one or more of the data capture device 101, the display device 102, the electronic device 104, the server 106, any other suitable device, or any combination thereof. At step 702, audio of a subject may be acquired via a data capture device. The data capture device may comprise a microphone.

At step 704, it may be determined that an audio threshold has been exceeded for a first length of time based on the audio of the subject. The audio threshold may comprise a threshold decibel level (e.g., maximum decibel level or minimum decibel level). For example, audio associated with a decibel level above a baseline audio setting (e.g., audio threshold) may be determined to satisfy a requirement for sending an alert notification to one or more user devices. The first length of time may comprise a user-programmable length of time. For example, the amount of decibels that exceeds the audio threshold may be a user-programmable setting. The first length of time may be different than the first length of time. In an example, the data capture device may determine a percentage of the first length of time that must contain significant audio (e.g., audio threshold being exceeded).

At step 706, a notification may be sent, via a local area network, to one or more user devices based on the audio threshold being exceeded for the first length of time. The one or more user devices may comprise one or more of a smartwatch, a haptic device, an audio/video monitor, a smartphone, a computer, a television, a set-top box, or a streaming device. In an example, sending the notification to the one or more user devices may cause the one or more user devices to one or more of exit a standby mode, output the one or more images, output the audio, or emit a haptic output. In an example, the one or more devices may be determined to receive the notification based on a schedule.

As an example, one or more values of one or more notification parameters may be determined. The one or more values of the one or more notification parameters may be provided to a predictive model (e.g., machine learning model, artificial intelligence, etc.) configured for predicting a likelihood that an alert event is occurring. The notification may be sent, via the local area network, to the one or more user devices based on receipt, from the predictive model, of the likelihood that an alert event is occurring, wherein the likelihood that the alert event is occurring exceeds an event threshold. The one or more notification parameters may comprise one or more of a type of sound in the audio, motion associated with the audio, a type of motion, facial recognition a light level, a quality of image, a detection zone, an ignore zone, a day of week, a time of day, a location of one or more users, an application setting, an amount of time since a previous notification, and the like.

As an example, the data capture device may also acquire one or more images of the subject. For example, the data capture device may further comprise an image sensor. For example, the data capture device may comprise one or more of a camera device, a smart camera, an infra-red sensor, a depth/motion capture sensor (e.g., RGB-D camera), a LiDAR sensor, and the like. The one or images may comprise video of the subject. It may be determined that a motion threshold has been exceeded for a second length of time based on the one or more images of the subject. The motion threshold may comprise a threshold amount of motion (e.g., maximum amount of motion or minimum amount of motion). For example, motion associated with an amount of motion determined (e.g., detected) above a baseline motion setting (e.g., motion threshold) may be determined to satisfy a requirement for sending an alert notification to one or more user devices. The second length of time may comprise a user-programmable length of time. For example, the amount of motion that exceeds the motion threshold may be a user-programmable setting. In an example, the data capture device may determine a percentage of the second length of time that must contain significant motion (e.g., motion threshold being exceeded). The notification may be sent, via the local area network, to one or more user devices based on the motion threshold being exceeded for the second length of time.

As an example, an indication from the one or more user devices that the notification is indicative of an alert event may be received. One or more notification parameters associated with the alert event may be determined based on the alert event. A predictive model (e.g., machine learning model, artificial intelligence, etc.) configured for predicting a likelihood that an alert event is occurring may be trained based on the one or more notification parameters. The one or more notification parameters may comprise one or more of a type of sound in the audio, motion associated with the audio, a type of motion, facial recognition, a light level, a quality of image, a detection zone, an ignore zone, a day of week, a time of day, a location of one or more users, an application setting, an amount of time since a previous notification, and the like.

As an example, it may be determined that the data capture device is not in communication with the local area network. A direct communication link may be established with the one or more user devices based on the data capture device not being in communication with the local area network. For example, the notification may be sent to the one or more user devices via one or more of a cellular network, a near-distance communication network, a wired connection, and the like.

As an example, the data capture device may establish a communication session with a remote computing device. The one or more images and audio may be received by the remote computing device via the communication session. The remote computing device may output the one or more images and the audio, may receive an input indicative of the alert event, and may send a notification indicative of the alert event. In an example, a user device of the one or more user devices may be determined to receive the notification indicative of the alert event.

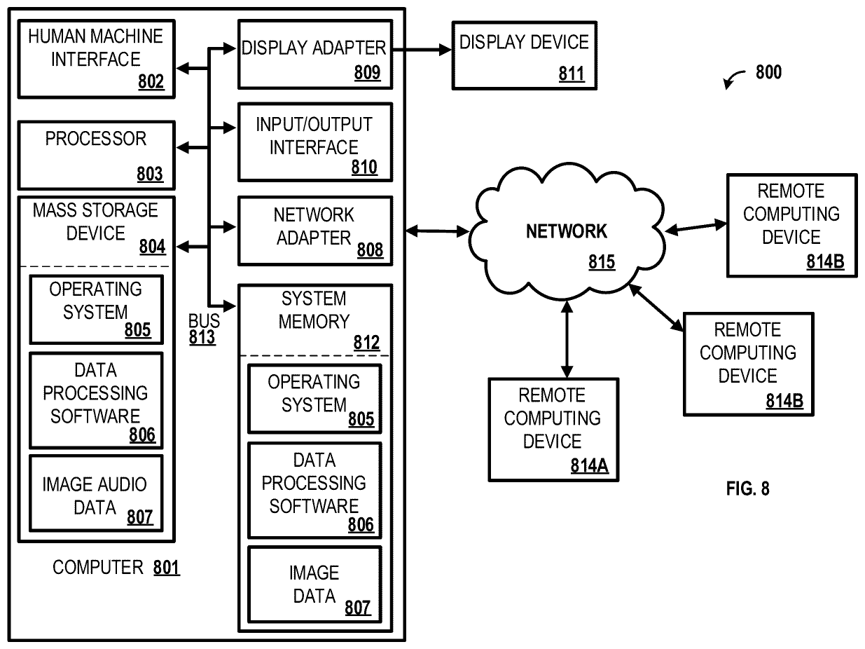

The methods and systems can be implemented on a computer 801 as illustrated in FIG. 8 and described below. By way of example, the data capture device 101, the display device 102, the electronic device 104 and/or the network device 108 of FIG. 1 and/or the can be a computer 801 as illustrated in FIG. 8. Similarly, the methods and systems disclosed can utilize one or more computers to perform one or more functions in one or more locations. FIG. 8 is a block diagram illustrating an example operating environment 800 for performing the disclosed methods. This example operating environment 800 is only an example of an operating environment and is not intended to suggest any limitation as to the scope of use or functionality of operating environment architecture. Neither should the operating environment 800 be interpreted as having any dependency or requirement relating to any one or combination of components illustrated in the example operating environment 800.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media such as memory storage devices.

Further, one skilled in the art will appreciate that the systems and methods disclosed herein can be implemented via a general-purpose computing device in the form of a computer 1001. The computer 801 can comprise one or more components, such as one or more processors 803, a system memory 812, and a bus 813 that couples various components of the computer 801 comprising the one or more processors 803 to the system memory 812. The system can utilize parallel computing.

The bus 813 can comprise one or more of several possible types of bus structures, such as a memory bus, memory controller, a peripheral bus, an accelerated graphics port, or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 813, and all buses specified in this description can also be implemented over a wired or wireless network connection and one or more of the components of the computer 801, such as the one or more processors 803, a mass storage device 804, an operating system 805, data processing software 806, image and audio data 807, a network adapter 808, the system memory 812, an Input/Output Interface 810, a display adapter 809, a display device 811, and a human machine interface 802, can be contained within one or more remote computing devices 814A-814C at physically separate locations, connected through buses of this form, in effect implementing a fully distributed system.

The computer 801 typically comprises a variety of computer readable media. Examples of readable media can be any available media that is accessible by the computer 801 and comprises, for example and not meant to be limiting, both volatile and non-volatile media, removable and non-removable media. The system memory 812 can comprise computer readable media in the form of volatile memory, such as random access memory (RAM), and/or non-volatile memory, such as read only memory (ROM). The system memory 812 typically can comprise data such as the image and audio data 807 and/or program modules such as the operating system 805 and the data processing software 806 that are accessible to and/or are operated on by the one or more processors 803.

In another aspect, the computer 801 can also comprise other removable/non-removable, volatile/non-volatile computer storage media. The mass storage device 804 can provide non-volatile storage of computer code, computer readable instructions, data structures, program modules, and other data for the computer 801. For example, the mass storage device 804 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 804, such as, by way of example, the operating system 805 and the data processing software 806. One or more of the operating system 805 and the data processing software 806 (or some combination thereof) can comprise elements of the programming and the data processing software 806. The image and audio data 807 can also be stored on the mass storage device 804. The image and audio data 807 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 815.

In another aspect, the user can enter commands and information into the computer 1001 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 803 via the human machine interface 802 that is coupled to the bus 813, but can be connected by other interface and bus structures, such as a parallel port, game port, an IEEE 1394 Port (also known as a Firewire port), a serial port, a network adapter 808, and/or a universal serial bus (USB).

In yet another aspect, the display device 811 can also be connected to the bus 813 via an interface, such as the display adapter 809. It is contemplated that the computer 801 can have more than one display adapter 809 and the computer 801 can have more than one display device 811. For example, the display device 811 can be a monitor, an LCD (Liquid Crystal Display), light emitting diode (LED) display, television, smart lens, smart glass, and/or a projector. In addition to the display device 811, other output peripheral devices can comprise components such as speakers (not shown) and a printer (not shown) which can be connected to the computer 801 via an Input/Output Interface 810. Any step and/or result of the methods can be output in any form to an output device. Such output can be any form of visual representation, comprising, but not limited to, textual, graphical, animation, audio, tactile, and the like. The display device 811 and the computer 801 can be part of one device, or separate devices.

The computer 801 can operate in a networked environment using logical connections to one or more remote computing devices 814A-814C. By way of example, a remote computing device 814A-814C can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 1001 and a remote computing device 814A-814C can be made via a network 815, such as a local area network (LAN) and/or a general wide area network (WAN). Such network connections can be through the network adapter 808. The network adapter 808 can be implemented in both wired and wireless environments. Such networking environments are conventional and commonplace in dwellings, offices, enterprise-wide computer networks, intranets, and the Internet.

For purposes of illustration, application programs and other executable program components such as the operating system 805 are illustrated herein as discrete blocks, although it is recognized that such programs and components can reside at various times in different storage components of the computing device 801, and are executed by the one or more processors 803 of the computer 801. An implementation of the data processing software 806 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Example computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques comprise, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, such as: matters of logic with respect to arrangement of steps or operational flow; plain meaning derived from grammatical organization or punctuation; the number or type of embodiments described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as examples only, with a true scope and spirit being indicated by the following claims.

What is claimed is:

1. A method comprising:
acquiring, via a data capture device, one or more images of a subject and audio of the subject;
withholding sending a notification, based on the one or more images of the subject indicating that a motion threshold has not been exceeded for a first length of time;
withholding sending a notification, based on the audio of the subject indicating that an audio threshold has not been exceeded for a second length of time;
determining, based on the one or more images or the audio, an occurrence of a notification override event; and
based on the notification override event, sending, via a local area network, a notification to one or more user devices.

2. The method of claim 1, wherein determining the occurrence of a notification override event comprises determining a classification of the one or more images or the audio by a predictive model configured for predicting a likelihood that a notification override event is occurring.

3. The method of claim 1, wherein determining, based on the one or more images or the audio, the occurrence of the notification override event comprises identifying in the one or more images or the audio one or more of a sound of choking, a sound of gagging, the subject lying face-down, a face of the subject covered by an object, or the subject attempting to crawl out of a crib.

4. The method of claim 1, wherein the data capture device comprises an image sensor and a microphone, and wherein the one or more user devices comprise one or more of a smartwatch, a haptic device, an audio/video monitor, a smartphone, a computer, a television, a set-top box, or a streaming device.

5. The method of claim 1, further comprising:
receiving an indication from the one or more user devices that the notification is indicative of a notification override event;
determining, based on the notification override event, one or more notification parameters associated with the notification override event; and
training, based on the one or more notification parameters, a predictive model configured for predicting a likelihood that a notification override event is occurring.

6. The method of claim 5, wherein the one or more notification parameters comprise one or more of a sound of choking, a sound of gagging, the subject lying face-down, a face of the subject covered by an object, or the subject attempting to crawl out of a crib.

7. The method of claim 5, wherein determining, based on the one or more images or the audio, the occurrence of the notification override event comprises:
determining one or more values of one or more notification parameters;
providing the one or more values of the one or more notification parameters to the predictive model configured for predicting the likelihood that the notification override event is occurring; and
receiving, from the predictive model, the likelihood that the notification override event is occurring,
wherein sending the notification to the one or more user devices is based on the likelihood that the notification override event is occurring exceeding an override event threshold.

8. The method of claim 1, further comprising:
determining that the data capture device is not in communication with the local area network; and
establishing a direct communication link with the one or more user devices.

9. The method of claim 1, wherein sending the notification to the one or more user devices causes the one or more user devices to one or more of: exit a standby mode, output the one or more images, output the audio, or emit a haptic output.

10. The method of claim 1, wherein determining, based on the one or more images or the audio, the occurrence of the notification override event comprises:
establishing, by the data capture device, a communication session with a remote computing device;
receiving, by the remote computing device, via the communication session, the one or more images and the audio;
outputting, by the remote computing device, the one or more images and the audio;
receiving, by the remote computing device, an input indicative of the notification override event; and
sending, by the remote computing device, a notification indicative of the notification override event.

11. A system comprising:
a data capture device configured to capture one or more images of a subject and audio of the subject; and
a computing device configured to:
acquire, via the data capture device, one or more images of the subject and audio of the subject,
withhold sending a notification, based on the one or more images of the subject indicating that a motion threshold has not been exceeded for a first length of time,
withhold sending a notification, based on the audio of the subject indicating that an audio threshold has not been exceeded for a second length of time,
determine, based on the one or more images or the audio, an occurrence of a notification override event, and
based on the notification override event, send, via a local area network, a notification to one or more user devices.

12. The system of claim 11, wherein the computing device is configured to determine the occurrence of a notification override event, the computing device is further configured to determine a classification of the one or more images or the audio by a predictive model configured for predicting a likelihood that a notification override event is occurring.

13. The system of claim 11, wherein the computing device is configured to determine, based on the one or more images or the audio, the occurrence of the notification override event, the computing device is further configured to identify in the one or more images or the audio one or more of a sound of choking, a sound of gagging, the subject lying face-down, a face of the subject covered by an object, or the subject attempting to crawl out of a crib.

14. The system of claim 11, wherein the data capture device comprises an image sensor and microphone, and wherein the one or more user devices comprise one or more of a smartwatch, a haptic device, an audio/video monitor, a smartphone, a computer, a television, a set-top box, or a streaming device.

15. The system of claim 11, wherein the computing device is further configured to:
receive an indication from the one or more user devices that the notification is indicative of a notification override event;
determine, based on the notification override event, one or more notification parameters associated with the notification override event; and
train, based on the one or more notification parameters, a predictive model configured for predicting a likelihood that a notification override event is occurring.

16. The system of claim 15, wherein the one or more notification parameters comprise one or more of a sound of choking, a sound of gagging, the subject lying face-down, a face of the subject covered by an object, or the subject attempting to crawl out of a crib.

17. The system of claim 15, wherein the computing device is configured to determine, based on the one or more images or the audio, the occurrence of the notification override event, the computing device is further configured to:
determine one or more values of one or more notification parameters;
provide the one or more values of the one or more notification parameters to the predictive model configured for predicting the likelihood that the notification override event is occurring; and
receive, from the predictive model, the likelihood that the notification override event is occurring,
wherein the computing device is further configured to send the notification to the one or more user devices based on the likelihood that the notification override event is occurring exceeding an override event threshold.

18. The system of claim 11, wherein the computing device is further configured to:
determine that the data capture device is not in communication with the local area network; and
establish a direct communication link with the one or more user devices.

19. The system of claim 11, wherein sending the notification to the one or more user devices causes the one or more user devices to one or more of: exit a standby mode, output the one or more images, output the audio, or emit a haptic output.

20. The system of claim 11, wherein the system further comprises a remote computing device, wherein the data capture device is further configured to establish a communication session with the remote computing device, wherein the remote computing device is configured to:
receive, via the communication session, the one or more images and the audio;
output, the one or more images and the audio;
receive an input indicative of the notification override event; and
send a notification indicative of the notification override event.
